(19) United States
(12) Patent Application Publication
(10) Pub. No.: US 2017/0188267 A1
(43) Pub. Date: Jun. 29, 2017

(54) Method And Apparatus For Network Bandwidth Measurement

(71) Applicants: Devanand Palanisamy, BANGALORE (IN); Avinash Pai, BANGALORE (IN); Vybhav Krishna, BANGALORE (IN); Saranya Rajendran, BANGALORE (IN); Giridharan L, BANGALORE (IN); Shashikiran Kolar, BANGALORE (IN)

(72) Inventors: Devanand Palanisamy, BANGALORE (IN); Avinash Pai, BANGALORE (IN); Vybhav Krishna, BANGALORE (IN); Saranya Rajendran, BANGALORE (IN); Giridharan L, BANGALORE (IN); Shashikiran Kolar, BANGALORE (IN)

(21) Appl. No.: 14/982,300

(22) Filed: Dec. 29, 2015

(51) Int. Cl. H04W 28/24; H04W 28/20; H04W 24/10

(52) U.S. Cl. CPC H04W 28/24; H04W 24/10; H04W 28/20

(57) ABSTRACT

A method and apparatus for measuring the available bandwidth between end points of a communication network for use, for example, in evaluating the provisioning of a new service through the network. In one embodiment, a method includes receiving a request proposing an additional service is proposed, determining the requested QoS associated with the service to be added, and running a bandwidth evaluation at the requested QoS. The method may further include running a bandwidth evaluation for at least a second QoS. The method may also include reporting the bandwidth availability for at least one QoS, or storing the bandwidth availability for at least one QoS, or both. The method may also include initiating the proposed new service.

### BACKGROUND

Field of the Disclosure

The present disclosure relates generally to network communication and, more particularly, to a method and apparatus for measuring available bandwidth in a communication network.

Description of the Related Art

The following abbreviations are herewith expanded, at least some of which are referred to within the following description of the state-of-the-art and the present invention.

CBS Committed Burst Size

EBS Excess Burst Size

IEEE Institute of Electrical and Electronics Engineers

IETF Internet Engineering Task Force

ITU International Telecommunication Union

LAN Local Area Network

RFC Request for Comments [an IETF designation]

SAC Service Acceptance Criteria

WAN Wide Area Network

A communication network includes multiple network nodes, or specially-configured computing devices that are configure for communication with other such devices. The content of the communications may be, for example, email, voice, or streaming video. The network nodes are interconnected so that they may not only send and receive communications between two nodes, but also to receive communications from one node and forward the communications to or toward another node. The various network nodes may be interconnected connected, for example, by metal or fiber optic cables or by wireless communication media.

Communications being transmitted through such a network are converted into digital data, which are divided into manageable bundles called frames or packets for transmission. Each frame or packet includes information about its destination address so that it may be properly forwarded to its final destination as well as information about how the multiple data frames or packets should be reassembled at their destination in order to reproduce the original communication.

As may be apparent, modern communication networks must operate according to standard protocols so that the various network nodes, some of which may be owned or managed by different operators, can work together efficiently. The protocols also permit the network to adapt quickly to changes in configuration, for example if additional nodes are added, existing ones taken out of service (or fail), or are altered or upgraded. One such standard protocol is known broadly as Ethernet, various aspects of which are described in a number of protocol documents promulgated by such organizations as the ITU, IEEE, or IETF.

In implementation communication networks may be quite small, such as a home network including only a handful of devices. Larger networks include LANs, which may for example connect together (a few or many) nodes at a business or similar organization. A WAN may cover a given geographic region and connect various LANs to each other or to yet another network for transmission elsewhere. For example, a company may want to connect the local network at one facility to a network at another. A bundle of communication capacity across a network, or multiple networks, is sometimes referred to as a service. The amount of this capacity may be described as bandwidth.

Note that the techniques or schemes described herein as existing or possible are presented as background for the present invention, but no admission is made thereby that these techniques and schemes were heretofore commercialized or known to others besides the inventors

### SUMMARY OF EMBODIMENTS

The following presents a summary of the disclosed subject matter in order to provide a basic understanding of some aspects of the disclosed subject matter. This summary is not an exhaustive overview of the disclosed subject matter. It is not intended to identify key or critical elements of the disclosed subject matter or to delineate the scope of the disclosed subject matter. Its sole purpose is to present some concepts in a simplified form as a prelude to the more detailed description that is discussed later.

In some embodiments, a method for facilitating the provision of a new service in an operating communication network may include receiving a request proposing an additional service, determining the requested QoS associated with the service to be added, and running a bandwidth evaluation at the requested QoS. The method may further include running a bandwidth evaluation for at least a second QoS. The method may also include reporting the bandwidth availability for at least one QoS, or storing the bandwidth availability for at least one QoS, or both. The method may also include initiating the proposed new service.

In some embodiments the method includes selecting the QoS parameters for the bandwidth evaluation. In some embodiments, the method includes performing an incremental evaluation. The incremental evaluation may be, for example, a top down or a bottom up incremental evaluation. In other embodiments, a binary bandwidth evaluation may be used.

In some other embodiments, apparatus is provided for facilitating the provisioning of a new service in an operating communication network. In one embodiment, the apparatus for managing network traffic includes a processor having a bandwidth calculator, a memory device in communication with the processor, the memory device embodying software program instructions that when executed by the processor causes the bandwidth calculator to receive a service proposal, determine a QoS associated with the service proposal, select evaluation parameters determine end points, execute a bandwidth evaluation, and accept a bandwidth evaluation result.

Additional aspects of the invention will be set forth, in part, in the detailed description, figures and any claims which follow, and in part will be derived from the detailed description, or can be learned by practice of the invention. It is to be understood that both the foregoing general description and the following detailed description are exemplary and explanatory only and are not restrictive of the invention as disclosed.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is a block diagram illustrating a communication network according to some embodiments;

FIG. 2 is a flow diagram illustrating a method according to some embodiments; and

FIG. 3 is a block diagram illustrating a network management node according to some embodiments.

### DETAILED DESCRIPTION

Described herein is a manner of determining the available bandwidth across a communication network between two end points. This solution may be of particular advantage in the provisioning of new services into an existing and operating Ethernet network.

FIG. 1 is a block diagram illustrating a communication network 100 according to some embodiments. In the embodiment of FIG. 1, a core network 101 is illustrated, and is representative of a number of, and usually many, individual network nodes; communication devices that are configured to receive, store, and forward transmissions according to one or more standard protocols such as Ethernet. Core network 101 may in fact include one or more sub-networks of such devices, including in some cases sub-networks operated by various network operators.

Also shown in the embodiment of FIG. 1 are numerous end points 110, 115, 120 and 125. Each of these endpoints represent a location where, for example, a customer or subscriber may access the core network 101 and through it devices or networks associated with a different subscriber location, other subscribers, or public networks such as the Internet. Also in communication with core network 101 is a network manager 105, which may be used for monitoring and controlling communication network 100 among other potential functions.

From time to time a subscriber or subscribers may wish to use communication network 100 for a new or not currently operational service. It may be difficult, however, to ascertain the impact of the proposed service on the network and whether the bandwidth is available to support the service without adversely impacting other existing or planned services.

FIG. 1 illustrates selected components of an embodiment and some variations are described above. Other variations are possible without departing from the claims of the invention as there recited. In some of these embodiments, illustrated components may be integrated with each other or divided into subcomponents. There will often be additional components in the device management server and in some cases less. The illustrations components may also perform other functions in addition to those described above.

FIG. 2 is a flow diagram illustrating a method 200 according to some embodiments. At START it presumed that the components for performing the method are available and operational according to at least this embodiment. The process then begins with receiving a service proposal (step 205). The service proposal may, for example, come from a network operator, customer, or potential customer and be received by a network management node in communication with a core network and various end points.

In the embodiment of FIG. 2, when a service proposal is received at step 205, a QoS (quality of service) associated with the proposal is determined (step 210). Note that as used herein, the QoS is to be broadly construed and includes any SAC (service acceptance criteria) associated with the proposal. Once the QoS is determined, the specific evaluation parameters to be used for the test are also determined (step 215). These parameters may be tests from a specified standard protocol, for example ITU-T Y.1564. They may also be non-standard parameters, for example as determined by a network operator or service subscriber. Here it is noted that steps 210 and 215 are not completely separate in all cases; the QoS, for example, may have been specified in terms of certain parameters.

In the embodiment of FIG. 2, the two end points for the test are then determined (step 220). It is presumed here that there are only two end points that will be subject to the testing, but in some embodiments an alternate pair of end points may also be tested (in an additional evaluation). In the embodiment of FIG. 2, a bandwidth evaluation is then conducted (step 225).

In some embodiments, the bandwidth evaluation is performed using a top down approach. Using a one or more of the predetermined parameters, a first of the selected two end points transmits toward the second selected end point at the line rate. The line rate is the maximum bandwidth available on the given physical link between the two end points. If the line rate is not known, a starting bandwidth may be selected in a number of ways, for example using a default bandwidth, or the bandwidth, if any associated with the service proposal, or a bandwidth that exceeds the proposal bandwidth by a certain percentage. If the service proposal is not associated with a bandwidth value, that of an existing service may be used. In any event, the success of the transmission is then determined (not separately shown). If the transmission is successful, that is the transmitted information traverses the network from one end point to the other at the determined QoS, then the available bandwidth is equal to the line (or other selected) rate.

In a top down embodiment, if the transmission is not successful, that is, if the required QoS is not supported, an incrementally lower bandwidth is selected and the test performed again (not separately shown). The increment may be determined in a variety of ways. Initially, of course, a standard decrement (amount of bandwidth) could be used. In other cases, a specified deviation for the proposed service may be used. That is, the test bandwidth is reduced by an absolute or percentage value commensurate with the deviation from the proposed QoS could be attempted. If the test is successful, the available bandwidth has now been determined (accurate to within the size of the decrement). In this case, of course, the result could be accepted (step 230) or one or more tests could be run at bandwidth values between the successful test and the last unsuccessful one. If the test is unsuccessful, however, the test bandwidth is again decremented and another test is run at the further reduced bandwidth. The decrements continue further, if necessary, until a result is accepted at step 230.

In other embodiments, a bottom up approach is used. Here, a relatively low bandwidth is used for the first test. Presuming it is successful, an incrementally higher bandwidth transmission is attempted (not separately shown). The increments may of course be chosen in the same manner as the decrements in the top down approach. When a test fails, the last successful result may accepted (step 230), or the evaluation may be further refined (not shown in FIG. 2) if desirable.

In still other embodiments, a binary approach is used. In this approach to bandwidth evaluation. A first test may be run at the line rate for the link between the two endpoints. If successful, the results generally considered acceptable (step 230), although again this result may be rare in operating networks. If unsuccessful, the test bandwidth is halved and the test tried again. If this second test is successful, at least one more test is conducted using a bandwidth incremented by one-half of the bandwidth of the previous test. Any unsuccessful test is followed by another at a bandwidth of the unsuccessful test but decremented by half. This process continues until the bandwidth of a successful test is accepted at step 230. Acceptance in this approach is based on, for example, the achievement of a certain number of successful tests (at different bandwidth values) or when the difference between the last two tests falls below a certain threshold value (with the highest successful test value being accepted). Here it is noted that the binary approach is similar to the refinement process described above in relation to the top down or bottom up approaches, and to a test procedure specified in IETF RFC 2544 for use in another context.

Regardless of whether one of the above-described approaches is used for bandwidth evaluation at step 225, the bandwidth for each test may be described in any acceptable manner. In some embodiments a CIR (committed information rate) is used, for example as that term is defined in the protocol ITU-T Y.1564 or a similar bandwidth description. Other test methodologies are described in that protocol as well for service configuration tests or service performance tests.

In addition, while the bandwidth evaluation has been described above in terms of a uni-directional test, from one end point to another, it could also be bi-directional. A bi-directional test may involve testing from each endpoint individually and then accepting the lowest (or in some cases, highest) successful bandwidth as the result. In other embodiments, a bi-directional test involves a round-trip transmission, with the QoS being measured at the originating end point after re-transmission from the original recipient end point. The latter evaluation could of course also be performed using both end points as the originating node and averaging or selecting the best resulting test.

Whatever the approach, once an available-bandwidth result is accepted at step 230, the result is reported (step 235). The result may also be stored (not shown) for use in future service considerations. Note that in some network, the available bandwidth between two end points may be determined on a regular or occasional basis for possible future use. Such tests may also be used to detect changing network conditions, and to initiate corrective action if the available bandwidth falls too low. In the embodiment of FIG. 2, however, presuming the result to be satisfactory, the new service may then be provisioned (step 235) in the communication network. If the results are for some reason not satisfactory, a service may still be provisioned at a lower bandwidth or QoS, as may be desirable in some situations.

Note that the sequence of operation illustrated in FIG. 2 represents an exemplary embodiment; some variation is possible within the spirit of the invention. For example, additional operations may be added to those shown in FIG. 2, and in some implementations one or more of the illustrated operations may be omitted. In addition, the operations of the method may be performed in any logically-consistent order unless a definite sequence is recited in a particular embodiment.

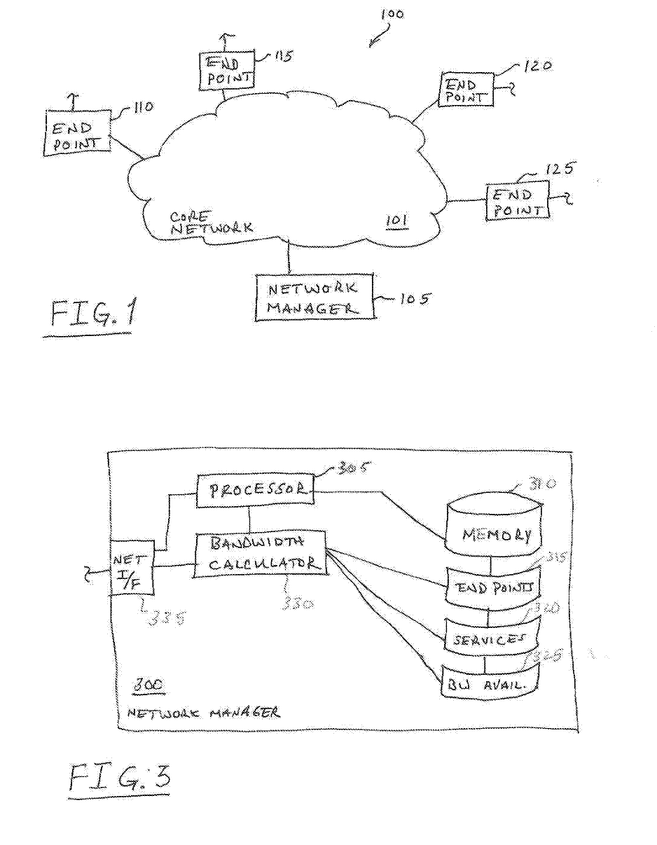

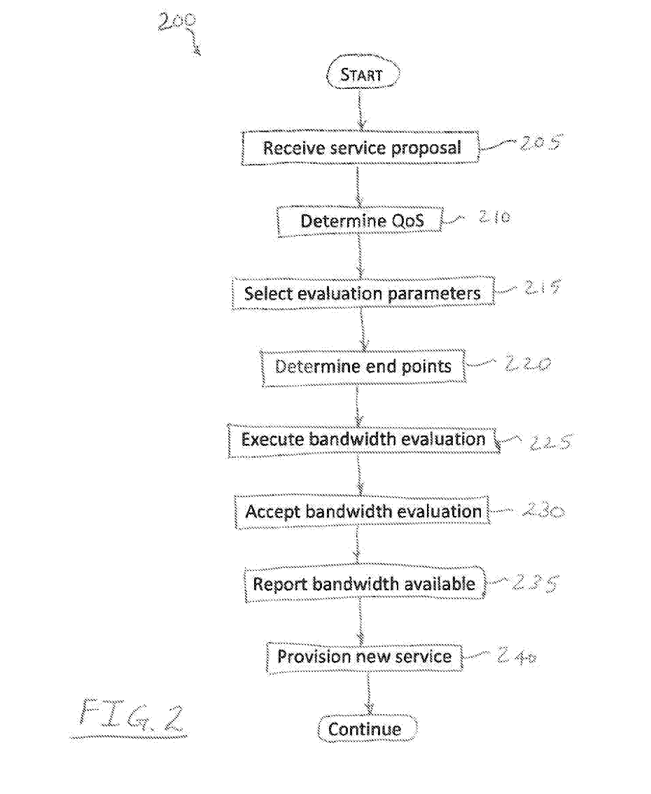

FIG. 3 is a block diagram illustrating a network management node 300 according to some embodiments. In this embodiment, management node 300 includes a processor 305 and a memory device 310. Processor 305 may be implemented in hardware in software executing on a hardware device. Memory device 310 in this embodiment is a physical storage device that may in some cases operate according to stored program instructions. In any case, memory 310 is non-transitory in the sense of not being merely a propagating signal, unless explicitly recited otherwise in a particular embodiment. Memory 310 is used for storing, among other things, data as well as stored program instructions for execution by processor 305.

Shown separately in FIG. 3 is an end points table 315 for storing the identity and address of end points associated with a communication network (see, for example, FIG. 1), a service table 320 for tracking those services that are or may utilize the communication network including, for example, the QoS associated with each. Also shown in this embodiment is an available bandwidth table 325 for storing values corresponding to the used and available bandwidth between the various endpoints listed in end points table 315 (as that information is available).

In the embodiment of FIG. 3, management node 300 also includes a bandwidth calculator for calculating the available bandwidth between two end points using, for example, one of the approaches described above or illustrated in FIG. 2. In the embodiment of FIG. 3, the management node 300 also includes a network interface 325 to permit communication with the end points of the communication network as well as other devices.

FIG. 3 illustrates selected components of an embodiment and some variations are described above. Other variations are possible without departing from the claims of the invention as there recited. In some of these embodiments, illustrated components may be integrated with each other or divided into subcomponents. There will often be additional components in the device management server and in some cases less. The illustrations components may also perform other functions in addition to those described above.

In some embodiments, certain aspects of the techniques described above may be implemented by one or more processors of a processing system executing software. The software comprises one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

A computer readable storage medium may include any storage medium, or combination of storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disc, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

Note that not all of the activities or elements described above in the general description are required, that a portion of a specific activity or device may not be required, and that one or more further activities may be performed, or elements included, in addition to those described. Still further, the sequence in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. A method for managing network traffic, comprising:
receiving a service proposal;
determining a QoS associated with the service proposal;
selecting evaluation parameters;
determining end points;
executing a bandwidth evaluation; and
accepting a bandwidth evaluation result.

2. The method of claim 1, further comprising storing the bandwidth evaluation result.

3. The method of claim 1, further comprising reporting the bandwidth evaluation result.

4. The method of claim 1, further comprising initiating the proposed service.

5. The method of claim 1, wherein selecting evaluation parameters comprises selecting evaluation parameters associated with the determined QoS.

6. The method of claim 1, wherein the bandwidth evaluation is performed using a top down approach.

7. The method of claim 1, wherein the bandwidth evaluation is performed using a bottom up approach.

8. The method of claim 1, wherein the bandwidth evaluation is performed using a binary approach.

9. Apparatus for managing network traffic, comprising:
a processor comprising a bandwidth calculator;
a memory device in communication with the processor;
wherein the memory device embodies software program instructions that when executed by the processor cause the bandwidth calculator to:
receive a service proposal;
determine a QoS associated with the service proposal;
select evaluation parameters;
determine end points;
perform a bandwidth evaluation; and
accept a bandwidth evaluation result.

10. The apparatus of claim 9, wherein the software program instructions further cause the bandwidth calculator to store the bandwidth evaluation result.

11. The apparatus of claim 9, wherein the software program instructions further cause the bandwidth calculator to report the bandwidth evaluation result.

12. The apparatus of claim 9, wherein the software program instructions further cause the bandwidth calculator to initiate the proposed service.

13. The apparatus of claim 9, wherein the bandwidth evaluation is performed using a top down approach.

14. The apparatus of claim 9, wherein the bandwidth evaluation is performed using a bottom up approach.

15. The apparatus of claim 9, wherein the bandwidth evaluation is performed using a binary approach.
